(19) United States
(12) Patent Application Publication
(10) Pub. No.: US 2010/0119099 A1
(43) Pub. Date: May 13, 2010

(54) Microphone and Method for Transmitting the Microphone Audio Data

(76) Inventors: Axel Haupt, Langenhagen (DE); Steve Bartlett, Thousand Oaks, CA (US)

Correspondence Address: FROMMER LAWRENCE & HAUG, 745 FIFTH AVENUE- 10TH FL., NEW YORK, NY, 10151, US

(21) Appl. No.: 11/991,704

(22) PCT Filed: Sep. 8, 2006
(86) PCT No.: PCT/EP2006/008773

§ 371 Date: Jan. 7, 2010

(30) Foreign Application Priority Data
Sep. 8, 2005 (DE) 10 2005 042 904.1

(51) Int. Cl. H04R 19/04

(52) U.S. Cl. 381/369

(57) ABSTRACT

There is provided a microphone which has a microphone capsule for recording audio signals, an A/D converter for digitizing the audio signals recorded by the microphone capsule and a semiconductor memory for storing the audio signals digitized by the A/D converter. The microphone further has an interface for transmitting the digital audio signals to an external receiver and a controller for controlling the microphone. The controller controls the microphone in a first operating mode for storing the digitized audio signals in the semiconductor memory and for transmitting the stored audio data by way of the interface at a later time. The controller controls the microphone in a second operating mode for direct transmission of the digitized audio signals by way of the interface. The controller switches into the first operating mode when errors occur in the second operating mode.

### CROSS-REFERENCE TO RELATED APPLICATIONS

This is a national phase application of International Application No. PCT/EP2006/008773, filed Sep. 8, 2006 which claims priority of German Application No. 10 2005 042 904.1, filed Sep. 8, 2005, the complete disclosures of which are hereby incorporated by reference.

### BACKGROUND OF THE INVENTION

a) Field of the Invention

The present invention concerns a microphone having an A/D converter, a semiconductor memory and an output interface. The present invention also concerns a method of transmitting audio data from a microphone to an external electronic device.

b) Description of the Related Art

Various microphones are available on the market, which have an interface such as for example a USB interface which can be connected directly to a computer. Such microphones can be used in a low price segment of the market in order to easily equip the computer with a possible way of speech input (dictating texts, gaming, Internet telephony). According to the uses involved those microphones are only equipped with a limited audio bandwidth. The mechanical implementation also does not satisfy professional demands.

Recording devices are also available on the market, having semiconductor memories for storing digitized audio signals. Those devices are designed for professional use and include a whole range of features. The stored digital audio signals can be transmitted to a PC by way of a digital interface. Here too, the USB interface is used, in which case the device is visible in the PC as an external storage medium. Alternatively the data are stored on removable storage media (CompactFlash, etc), which can then be read out by way of suitable reading devices on the PC. Frequently, an application program which is to be installed on the PC is also supplied on a CD, which makes it possible to conveniently make various settings for the recording device on the PC.

By virtue of the extensive fitment with digital components including large displays and operating elements, those devices are quite large and in structural form are similar to measuring devices rather than microphones.

An integrated microphone suffers, when that structural form is involved, because of the lack of acoustic properties of the housing. Acoustic quality is thus not optimum. For that reason, some manufacturers have gone over to fitting a microphone to the housing on the outside thereof. That admittedly improves acoustic quality but the measurement device character is even more emphasised thereby.

That structural form can also lead to acceptance problems in use. In regard to simultaneous recording of the situation by way of TV cameras, such a device is possibly rejected by the video directors or there is not enough space on the lectern to set up the device, or the interviewee finds such a device unfamiliar.

DE 102 34 066 A1 discloses a microphone unit having a recording device, wherein the microphone unit and the recording device are connected together by way of an XLR plug connection. The recording device has a semiconductor memory. The recording device can have a wireless interface for communication with external devices. Accordingly the audio data recorded by the microphone can be put into intermediate storage and then transmitted to an external unit.

### OBJECT AND SUMMARY OF THE INVENTION

The primary object of the present invention is to provide a microphone having at least satisfactory acoustic properties and having a storage capability for the recorded audio signals, which avoids the above-indicated problems.

That object is attained by a microphone comprising a microphone capsule for recording audio signals; an A/D converter for digitizing the audio signals recorded by the microphone capsule; a semiconductor memory for storing the audio signals digitized by the A/D converter; an interface for transmitting the digital audio signals to an external receiver; and a controller for controlling the microphone in a first operating mode for storing the digitized audio signals in the semiconductor memory and for transmitting the stored audio data by way of the interface at a later time and for controlling the microphone in a second operating mode for direct transmission of the digitized audio signals by way of the interface. The controller switches into the first operating mode when errors occur in the second operating mode.

The object is further attained by a method of transmitting audio data from a microphone comprising the steps of recording audio signals; digitizing the recorded audio signals; storing the digitized audio signals; transmitting the digital audio signals to an external receiver; controlling the microphone in a first operating mode for storing the digitized audio signals and for transmitting the stored audio data at a later time; and controlling the microphone in a second operating mode for direct transmission of the digitized audio signals. Switching into the first operating mode is effected if errors occur in the second operating mode.

Accordingly there is provided a microphone having an integrated electronic semiconductor memory. The microphone has an A/D converter for digitizing the audio signals recorded by the microphone, and also an output interface for output of the recorded digitized audio signals. In that arrangement the microphone can be operated in a first and a second operating mode.

In a first operating mode the microphone can store the digitized audio signals in an integrated data memory and at a later time reproduce them or transmit them to a computer. In a second operating mode the microphone can transmit the digitized audio signals directly for example to a computer, with the integrated memory serving as a buffer. If gaps, even of relatively long duration, occur in the transmission, the digital audio data which are still arriving are put into intermediate storage in the memory, that is to say the microphone is operated in a first operating mode.

The microphone changes automatically from the second operating mode to the first operating mode if fewer data can be transmitted than are produced in the digitization operation.

An above-described microphone can be implemented by a conventional hand-held (radio) microphone. That means that no compromises are necessary in regard to acoustic quality. The electronic circuitry required for the additional function is integrated into that microphone and has to be adapted to the corresponding space conditions. Only a few keys and a small display are installed for operation, in order to be able to display and set a few important parameters. Accordingly such a recording device is of a familiar visual appearance and affords optimum acoustic quality.

As an alternative thereto such a microphone can be operated with interchangeable microphone heads in order to be able to do better justice to different recording situations by altering the directional characteristic of the microphone.

Further configurations of the invention are subject-matter of the appendant claims.

The invention is described in greater detail hereinafter with reference to the drawings.

### BRIEF DESCRIPTION OF THE DRAWINGS

In the drawings:

FIG. 1 shows a block diagram of a microphone according to a first embodiment;

FIG. 2 shows a diagrammatic view of a system with a microphone and a connected computer according to the second embodiment;

FIG. 3 shows a block diagram of a power supply for a microphone according to a third embodiment;

FIG. 4 shows a block diagram of a microphone according to a fourth embodiment;

FIG. 5 shows a diagrammatic view of a microphone according to the fifth embodiment together with an external computer;

FIG. 6 shows a diagrammatic view of a microphone according to a sixth embodiment;

FIG. 7 shows a diagrammatic view of a microphone according to a seventh embodiment; and

FIG. 8 shows a diagrammatic view of a microphone according to an eighth embodiment.

### DESCRIPTION OF THE PREFERRED EMBODIMENTS

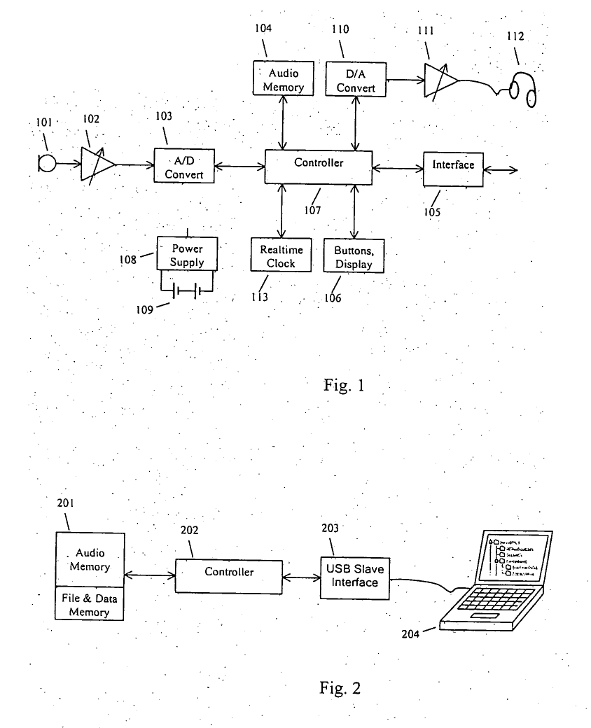

FIG. 1 shows a block diagram of a microphone according to a first embodiment of the invention. The microphone has a microphone capsule 101 which is fixedly mounted or adapted to be pluggable/changeable, an adjustable preamplifier 102 for the microphone signal from the microphone capsule 101 and an analog/digital converter 103. The arrangement also has a semiconductor memory 104 for storing large amounts of audio data, an interface 105 for transmission of the digital audio data to a receiver and operating and display devices 106. The microphone has a programmable microcontroller or a programmable logic circuit 107 for operation of all components and for operation of the device as well as providing the supply voltage 108 with a battery feed 109.

Optionally it is possible to add a digital/analog converter 110, an adjustable headset amplifier 111 and a clock function unit 113 with date and clock time.

The basic function of the microphone represents digital storage of the audio signal which is recorded by the microphone capsule 101 and digitized by the A/D converter 103, in the integrated semiconductor memory 104. The beginning and end of the recording and the recording parameters (sampling rate, filtering and so forth) can be selected by the user. The audio signal can be listened to selectively during or after recording, by way of a headset output 112a. The clock function unit 113 serves to provide the recording data with time marks. If required the clock 113 can be set by way of the operating devices or under remote control by way of the interface 105 from an external receiver.

The digital audio data are sent by way of the interface 105 to an external receiver which provides for long-term storage and optionally any necessary processing.

The design configurations of the interface are described in greater detail hereinafter.

FIG. 2 shows a diagrammatic view of a system comprising a microphone and a connected computer in accordance with the second embodiment. The microphone of the second embodiment has a memory 201 for audio data and for storing software and further data, a controller 202 and a USB slave interface 203.

The microphone further has a microphone capsule 101, a preamplifier 102 and an analog/digital converter 103 as described with reference to FIG. 1. In addition to the storage space the audio data memory 201 also contains application programs and operating data. The controller 202 emulates an external mass storage device by way of a USB interface 203 by responding to the protocol produced by an external computer 204. Accordingly in the connected computer 204 all data are visible as data files in register structures and can be correspondingly handled. The start of an application program only requires the usual starting mechanism, for example a double click in the case of Windows-based computers. If application programs are made available for Windows and Mac operating systems, a large part of the installed computer basis is covered.

Even while the microphone is connected to the USB bus, it is capable of recording and digitizing microphone signals. The data are then not stored in the internal audio data memory 201 but outputted directly by way of the USB interface 203. In that case the microphone appears as an audio device at the computer insofar as it correspondingly responds to the protocol produced by the computer.

The microphone can thus also be used to play audio signals directly into a computer (hard disk recording, etc).

As, with extensive USB cabling, other services running at the same time on the bus have to be supported by the host computer on the bus, there could be situations in which transport of the digital audio data cannot be guaranteed, with the necessary transmission capacity. In that case the internal intermediate memory 201 serves for buffering the digital audio data which are further occurring. When sufficient transmission capacity is available again, the buffer 201 is emptied or cleared again.

Electronic devices available nowadays already appear to a computer as an external mass storage device. That means that the audio data are visible as normal data files and as such can be copied, transmitted or erased.

Preferably in addition to the audio data further data files are stored in the microphone or in the semiconductor memory 104, namely an application program for the computer for setting parameters, setting the clock time and defining parameter sets for different recording conditions, a database with the various parameter sets, software for post-processing of the audio data and software for sending the audio data.

That expansion means that it is no longer necessary for the above-indicated data or software for processing to be installed on the computer. As nowadays practically all computer operating systems automatically recognize external mass storage devices on the USB bus, it is sufficient to plug in the microphone in order to make the processing software immediately available on any computer. The user is therefore not reliant on a given computer with installed software.

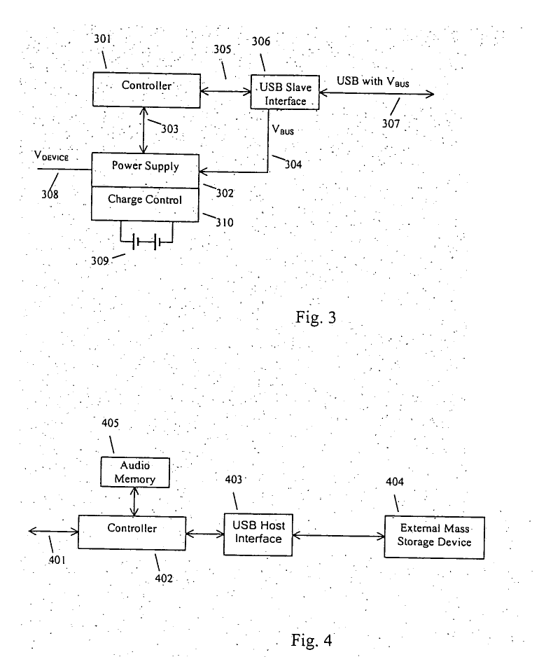

FIG. 3 shows a block diagram of a power supply of a microphone according to a third embodiment. The power supply circuit for the microphone of the third embodiment comprises a controller 301 and a USB slave interface 306 which can be connected to the USB bus 307. The power supply also has a power supply unit 302, a charging circuit 310 and a battery 309. A supply voltage V_{BUS} is applied on the USB bus 307. The USB interface 306 recognizes that and indicates it in its internal registers. The controller 301 can query that by way of the data lines 305. If the controller recognizes the applied supply voltage it actuates the power supply 302 in such a way that the device is supplied by way of the voltage 304 instead of by way of the battery 309, by the USB bus 307. Optionally, the battery 309 can additionally be charged up again by the supply voltage 304 by way of the charging circuit 310.

The USB bus preferably supplies power to the connected devices. For that purpose the computer puts a supply voltage on the bus, which is available at the USB slave interface 203. The microphone can therefore take its power from the USB bus in the connected condition. Accordingly no power from the integrated battery is consumed in that time. The power supply circuit for that purpose includes a change-over switch for switching over from battery supply to bus supply.

The supplied energy can also be used for charging the integrated battery up again as long as the device is connected to the USB bus. For that purpose the power supply circuit includes a charging circuit for the battery.

For faster and simplified operation of the device, predefined parameter sets in the form of data files can be stored on the computer by means of an application program. Those files can then be easily shifted into the register structure of the microphone by way of computer programs which are present. The microphone automatically recognizes a freshly loaded parameter set and appropriate sets itself. If the parameter set is constructed in the form of a text file, no special application program is necessary to produce the data file. On the basis of an example file, definition of the parameters can then be effected with a text editor.

As an alternative to implementation of the interface (described here) in the form of a USB interface, the interface can also be implemented for example in the form of a FireWire interface or a similar computer interface.

FIG. 4 shows a block diagram of a microphone according to a fourth embodiment. Here the interface of the microphone is described in greater detail in the form of a USB host interface. The microphone (besides the units described with reference to FIG. 1) has a controller 402, an audio data memory 405 and a USB host interface 403 which can be connected to an external mass storage device 404. The incoming audio data 401 from the microphone capsule 101 are transmitted by the controller 402 directly by way of the interface 403 to the external mass storage device 404. In that situation the controller 402 emulates a computer by producing the corresponding protocol with the USB interface 403.

By virtue of the implementation of a host interface the microphone thus becomes the controlling active device. As a result it is possible to connect external mass storage devices such as for example a Memory Stick or a hard drive to the microphone. The internal memory 104, 201 for audio data can then be entirely omitted or implemented with a lower capacity.

The external mass storage device 404 can also be separated from the microphone after recording. After connection of the memory to a computer the data can be correspondingly read out. In addition it is possible to provide application programs and further data on the external mass storage device so that the same advantages of a common storage means as described above are enjoyed here.

If nonetheless there is also an internal audio data memory 405 the external storage device 404 can be changed without interrupting the recording, that is to say the microphone is operated in a first operating mode. The internal memory 405 buffers the audio data which are arriving in the meantime from the microphone capsule. When an external storage device 404 is available again, those data are also transmitted.

If in the meantime no external mass storage device is available the audio data are put into intermediate storage in the internal audio memory 405.

In accordance with a further embodiment the functionalities of the USB slave interface of FIG. 2 and the USB host interface of FIG. 4 can be combined if what is referred to as a USB on-the-go interface is implemented. That interface is capable of operating both as a slave and as a host.

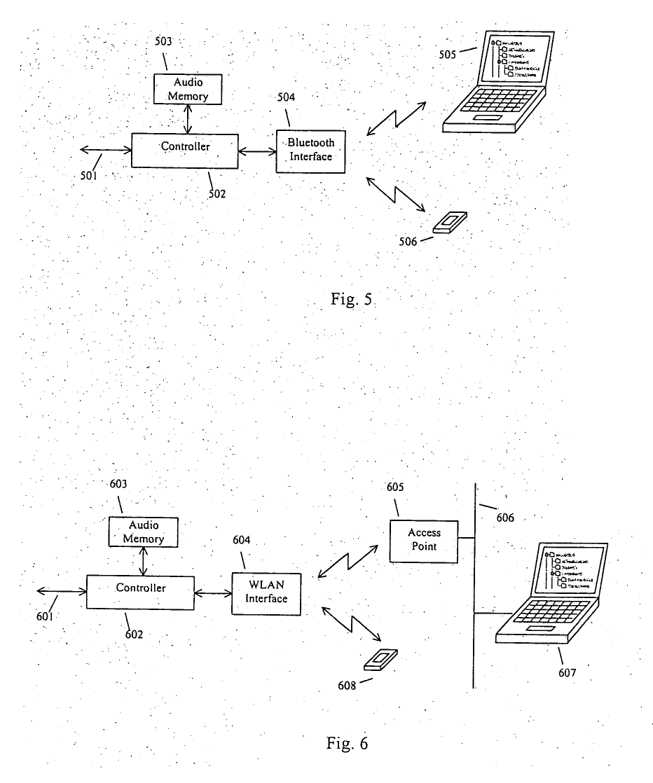

FIG. 5 shows a diagrammatic view of a microphone of a fifth embodiment together with an external computer. The microphone (besides the units described with reference to FIG. 1) comprises an audio memory 503, a controller 502 and a Bluetooth interface 504.

The incoming digitized audio data 504 are forwarded by the computer 502 to the Bluetooth interface 504 for transmission. The computer 505 receives the data and stores them on its internal hard drive.

If remote control commands are to be communicated, they are inputted at the computer 505 or alternatively at the hand device 506. The Bluetooth interface 504 receives them by way of the return path from the computer or hand device to the microphone and transmits them to the controller 502. Audio data 501 which in the meantime are coming in are put into intermediate storage in the memory 503.

When status data are to be transmitted the controller 502 sends them by way of the interface 504 to the computer 505 and/or to the remote control device 506. Audio data 501 which in the meantime are coming in are put into intermediate storage in the memory 503.

In accordance with the fifth embodiment the interface can be implemented in the form of a wireless Bluetooth interface. The wireless Bluetooth interface permits data transmission between an electronic device such as for example the microphone and a computer without using a cable. The audio data can be sent to the computer both after recording (first mode of operation) and also already during recording (second mode of operation). In that case the computer 505 can be at a distance of some meters away.

If a transmission error occurs, that is notified to the microphone by the computer 505 by way of the return path and transmission of a data packet is repeated. The digital audio data which in the meantime are possibly coming in are put into intermediate storage in the internal audio data memory 503.

If no receiving computer is in the vicinity the data are stored in the internal audio memory 503. When the microphone moves back into a region of a preconfigured computer which is ready for reception, transmission of the data into the computer is automatically begun. The microphone can check for example at regular time intervals whether a computer which is ready for reception is in the transmitting/receiving region.

At the same time remote control of the microphone can be effected by way of the Bluetooth interface 504 (and in particular the return path that this entails from the microphone to the computer). That therefore affords the possibility of setting up the microphone for example on a lectern and providing for remote control from some distance of the beginning and end of the recording, as well as important recording parameters. At the same time the digitized audio signal can be transmitted in parallel to the computer 505. If the transmission channel is occupied by remote control signals, the incoming audio data are put into intermediate storage in the internal memory 503 of the microphone. Remote control can be effected from the computer which receives the audio data but also from a separate remote control device.

The remote control device 506 can be for example a mobile electrical apparatus such as for example a handheld computer or cellular phone if it supports the corresponding Bluetooth remote control profiles or is suitably equipped by special application software.

The microphone can send status data to the computer and/or the remote control device at regular short intervals or alternatively upon enquiry by way of the remote control 506. In that way the user is constantly informed about the internal parameters of the microphone (for example modulation, filling status of the internal memory, battery capacity) and can make any adjustments that may be necessary.

Predefined parameter sets can be activated by way of the remote control. In that respect the parameter sets can be stored in the remote control 506, in the computer 505 or in the microphone.

This operating mode profits in particular from the automatic change between the operating modes as dropouts or lack of capacity in transmission do not have the result that recorded digitized audio data are lost or defective data packets are stored in the receiver.

FIG. 6 shows a diagrammatic view of a microphone according to a sixth embodiment. An implementation of the interface of the microphone based on a WLAN interface is described in greater detail here. The microphone (besides the units described with reference to FIG. 1) has an audio data memory 603, a controller 602 and a WLAN interface 604. By means of the WLAN interface 604, the microphone can communicate wirelessly by way of an access point 605 with an external computer 607 or wirelessly with a hand device 608. The incoming digitized audio data 601 are forwarded from the controller 602 to the WLAN interface 604 for transmission. The access point 605 receives the data and feeds them into the network 606. The receiving computer 607 receives the audio data from the network and stores them on its internal hard drive.

If remote control commands are to be communicated, they are inputted at the computer 607 or alternatively at the hand device 608. The WLAN interface 604 receives them and transmits them to the controller 602. Audio data 601 which in the meantime are coming in are put into intermediate storage in the memory 603.

If status data are to be transmitted the controller 602 sends them by way of the interface 604 to the computer access point 605 and/or to the remote control device 608. Audio data 601 which are in the meantime coming in are put into intermediate storage in the memory 603.

The use scenarios referred to for the Bluetooth interface also apply here, in particular also the automatic change between the operating modes. As a WLAN interface operates with a higher transfer rate, it is possible for a plurality of microphones to be caused to operate parallel on one computer. In regard to remote control the microphones are addressed by individual identifications and in that way can be individually controlled. The individual identifications of the microphones can represent for example IP addresses so that the microphone operates like a network node within the WLAN network. That therefore provides that the microphone can be addressed by way of the external network directly and immediately by way of its IP address and can correspondingly communicate with the network. If the recording takes place in a suitably equipped building the microphone can play the digitized audio data directly into a network by accessing the network by way of an access point. The receiving computer can then be located anywhere in the network.

Transmission capacity which is possibly lacking from time to time in the network (quality of service not sufficient), the microphone can compensate for this by providing for intermediate storage of audio data in its internal audio memory and passing them on later.

If recording takes place outside a suitably equipped building the audio data are stored in the internal audio memory. When the device is then moved into the region of an access point it automatically communicates with a preconfigured computer and transmits the stored data.

With a WLAN-capable remote control device (for example a handheld computer or cellular phone), the microphone can be remote controlled, as when equipped with Bluetooth.

The display of status data also functions accordingly. Predefined parameter sets can additionally be called up by way of the network.

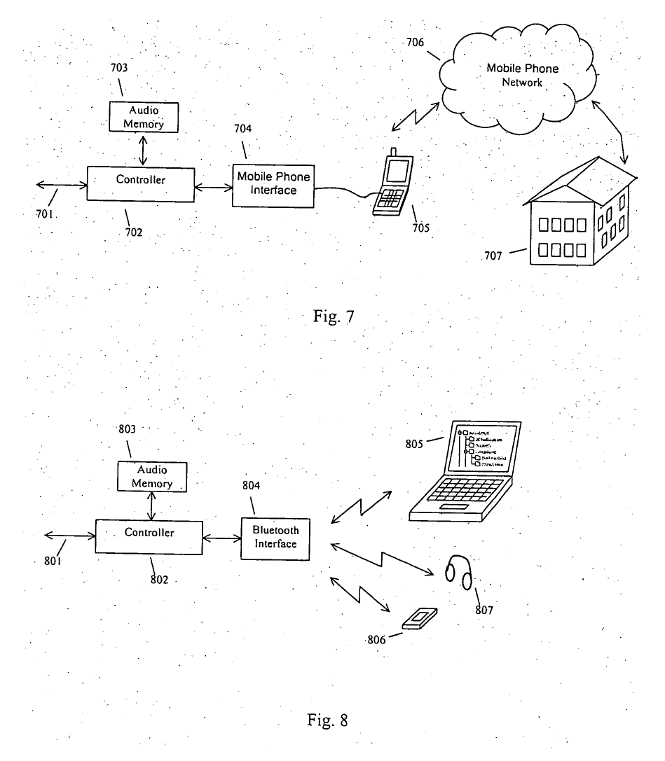

FIG. 7 shows a diagrammatic view of a microphone in accordance with a seventh embodiment. An implementation of the interface by a cellular phone interface is described in greater detail here. In other words the audio data to be transmitted are transmitted by way of a cellular phone connection. The microphone (besides the units described with reference to FIG. 1) comprises a controller 702, an audio memory 703 and a cellular phone interface 704. By means of the cellular phone interface 704 the microphone can be connected to a cellular phone 705 which in turn can communicate by way of a cellular phone network 706 with a receiver 707. Direct transmission of audio data to a receiver which is far away can be embodied in that way.

The incoming digitized audio data 701 are forwarded by the computer 702 to the cellular phone interface 704 for transmission purposes. The cellular phone 705 transmits the data by way of the telephone network 706 to the receiver 707. The receiver in that case can be again a cellular phone or a fixed network connection.

If audio data 701 have to be put into intermediate store the controller 702 temporarily stores them in the audio memory 703.

By way of the USB host interface it is possible to form a connection to a cellular phone and to transmit data by way thereof. Alternatively, for connection to the cellular phone, a serial interface based on the RS-232 standard, a WLAN or a Bluetooth connection is also possible.

Cellular phones can transmit data in large amounts by way of the data channel, the GPRS protocol or the HSCSD protocol, and modern variants also by way of UMTS.

The microphone can form a data connection to a remote counterpart station by way of suitable actuation. As the connection uses the worldwide cellular phone network, there is no limitation as to where the microphone and the receiver are to be found. The sole prerequisite is that the microphone is in a serviced region.

In the event of incorrectly transmitted data packets or a mobile radio connection which collapses at times the connection is possibly re-made and data packets re-sent. Digital audio data which are received in the interim are put into intermediate storage in the internal audio memory 703 of the microphone.

The connection by way of the mobile radio network can be used both for the transmission of stored data and also for direct transmission.

If a USB slave interface is integrated in the microphone the connection can be made by way of a cellular phone by means of an interposed computer.

FIG. 8 shows a diagrammatic view of a microphone in accordance with an eighth embodiment. An implementation of a microphone with a Bluetooth interface is described in greater detail here. Inter alia the microphone has (besides the units described with reference to FIG. 1) an audio memory 803, a controller 802 and a Bluetooth interface 804. The microphone of the eighth embodiment is substantially based on the microphone of the fifth embodiment.

When a Bluetooth interface 804 is used it can advantageously be used at the same time in particular for also listening to the audio signal from the microphone. In the storage mode the microphone sends a data stream to the Bluetooth headset 807. When the data are sent directly to a computer 805 a second data stream to the headset 807 is produced. Data packets are then sent alternately to the computer and to the headset.

All use scenarios as described hereinbefore in relation to the Bluetooth interface and FIG. 5 are maintained. The headset therefore only represents an expansion or supplement.

The user when working with the microphone is concentrating on recording and possibly at the same time on an interview. In that respect he overlooks possible indications which are signalled to him in the display unit. Those indications can relate for example to insufficient voltage supply or other errors which occur.

It is therefore particularly advantageous for the user if he receives an acoustic message in the headset, when a particular operating state is to be displayed. In the simplest case the acoustic message can be a signal sound which causes the user to look at the device. In the event that the internal battery is approaching the empty state or the storage capacity of the audio memory is exhausted the signal sound can sound with an increasing length or at intervals which become progressively shorter.

In a further advanced implementation a clear text message can be played out to the user. During the acoustic message the audio signal of the microphone is lowered in volume so that the user can properly perceive the message.

When using a USB/FireWire host interface Bluetooth or WLAN radio modules which are available on the market can be retro-fitted by plugging connection. That provides that the microphone can be used both in wired and also wireless form. All the above-described use scenarios are embraced thereby.

Optionally after digitization of the audio data an audio data compression algorithm can be applied. In that way the amount of data for storage is reduced, whereby the available memory capacity can be selected to be less or a longer recording duration is achieved, or a shorter transmission time to the computer is the result, or less transmission capacity is necessary for a wireless connection.

Optionally a parameter can be stored in the microphone, which represents a default value for the file name of a recorded audio signal. That file name can be respectively supplemented by date and clock time, read out of the clock function in FIG. 1. That makes it possible to determine a unique association of the recording in relation to specific situations, by suitably presetting the file name parameter in text form.

With the above-described microphones with the respective interfaces, the interface is so designed that a return path from an external electronic device to the microphone is possible. By virtue of that return path the microphone can be for example remotely controlled or various settings of the microphone parameters can be implemented from the external electronic device. Furthermore the return path can also be used for communication between the external electronic device and the microphone. Thus for example a warning signal can be communicated from the external electronic device to the microphone by way of the return path. In addition for example items of information or data can be communicated to the microphone, which can then be represented for example on the display 106. Some elements of the microphone are not explicitly shown in FIGS. 2 through 8. Those elements can be for example the microphone capsule, the preamplifier, the A/D converter, the clock, the display, the D/A converter and/or the headset amplifier, as are shown in FIG. 1. The transmission paths between the microphone and the external devices can each be of a bidirectional nature so that there is a return path between the external electronic device and the device itself.

Communication of the recorded digitized audio data from the microphone to the external computer can be effected in packets, in which respect the packets can also be redundantly sent or transmitted. Transmission of the digitized audio data to the external computer can be effected in dependence on the bandwidth of the transmission path so that the digitized audio data can be transmitted at different rates.

The above-described wireless transmission between a wireless interface of the microphone and an external electronic device can be based for example on the following technologies: Bluetooth, WLAN, wireless USB UWB (ultra-wide band), infrared, ultrasound and/or mobile radio technology. As an alternative thereto it is possible to provide a proprietary HF path for a high frequency transmission between the wireless interface and the external electronic device.

Although automatic switching-over between the first and second operating modes is described in the foregoing embodiments, when for example errors occur in the second operating mode, switching-over between the first and second operating modes can also be effected or initiated by an external electronic device or control unit, insofar as a corresponding control signal is communicated by way of the return path from the electronic device to the wireless interface, which forwards that signal to the controller so that the controller switches from the first operating mode into the second operating mode or vice-versa.

In the second operating mode and in the later transmission of the data in the first operating mode the microphone asks for an answer signal or an acknowledgement signal from the receiving electronic device in order thus to establish whether errors have occurred during transmission. If the interface of the microphone however does not receive an answer signal or an acknowledgement signal from the receiving electronic device in the communication of such a signal, that is automatically assessed by the controller as defective transmission and the controller switches the microphone into the first operating mode.

While the foregoing description and drawings represent the present invention, it will be obvious to those skilled in the art that various changes may be made therein without departing from the true spirit and scope of the present invention.

What is claimed is:

1-10. (canceled)

11. A microphone comprising:
a microphone capsule for recording audio signals;
an A/D converter for digitizing the audio signals recorded by the microphone capsule;
a semiconductor memory for storing the audio signals digitized by the A/D converter;
an interface for transmitting the digital audio signals to an external receiver; and
a controller for controlling the microphone in a first operating mode for storing the digitized audio signals in the semiconductor memory and for transmitting the stored audio data by way of the interface at a later time and for controlling the microphone in a second operating mode for direct transmission of the digitized audio signals by way of the interface;
wherein the controller switches into the first operating mode when errors occur in the second operating mode.

12. A microphone as set forth in claim 11 wherein at least one application program and/or operating data are stored in the semiconductor memory, wherein the application programs are forwarded by way of the interface to an external data processing unit in such a way that the application programs can be executed on the external data processing units without the application program being previously stored on the external data processing unit.

13. A microphone as set forth in claim 11 wherein the interface is adapted to provide a return path with an external electronic device so that the external electronic device can communicate with the microphone and/or can control the microphone.

14. A microphone as set forth in claim 11 comprising a digital/analog converter and a headset output for outputting the digitized audio signals to an external headset.

15. A microphone as set forth in claim 11 wherein the interface is in the form of a host interface in order in that way to control external electronic devices, in particular an external storage device.

16. A microphone as set forth in claim 11 wherein the microphone can be controlled or remotely controlled by way of the return path by an external electronic device.

17. A microphone as set forth in claim 11 wherein the microphone is in the form of a wireless microphone and the interface is in the form of a wireless interface.

18. A method of transmitting audio data from a microphone comprising the steps of:
recording audio signals;
digitizing the recorded audio signals;
storing the digitized audio signals;
transmitting the digital audio signals to an external receiver;
controlling the microphone in a first operating mode for storing the digitized audio signals and for transmitting the stored audio data at a later time; and
controlling the microphone in a second operating mode for direct transmission of the digitized audio signals;
wherein switching into the first operating mode is effected if errors occur in the second operating mode.

19. An audio recording system comprising:
a microphone as set forth in claim 11; and
an electronic device for receiving the audio signals transmitted by the microphone and/or for controlling the microphone.

20. A system as set forth in claim 19 wherein the electronic device has a computer, a cellular phone, a wireless headset and/or a PDA.
